(19) United States
(12) Patent Application Publication
(10) Pub. No.: US 2023/0223206 A1
(43) Pub. Date: Jul. 13, 2023

(54) ELECTROCHEMICAL DEVICE

(71) Applicant: Panasonic Intellectual Property Management Co., Ltd., Osaka (JP)

(72) Inventors: HIROKI HAYASHI, Kyoto (JP); NAO MATSUMURA, Osaka (JP); HIDEKI SHIMAMOTO, Kyoto (JP); SHOHEI MASUDA, Kyoto (JP); HIDEO SAKATA, Osaka (JP); HIROYUKI MAESHIMA, Hyogo (JP)

(21) Appl. No.: 18/000,276

(22) PCT Filed: May 18, 2021
(86) PCT No.: PCT/JP2021/018831

§ 371 Date: Nov. 29, 2022

(30) Foreign Application Priority Data
Jun. 30, 2020 (JP) 2020-113623

(51) Int. Cl. H01G 11/06; H01G 11/48; H01G 11/50

(52) U.S. Cl. CPC H01G 11/06; H01G 11/48; H01G 11/50

(57) ABSTRACT

An electrochemical device includes a positive electrode that includes an active layer containing a polyaniline compound. An infrared absorption spectrum of the active layer has a first peak, a second peak, a third peak, and a fourth peak that are derived from the polyaniline compound. The first peak appears at a wave number in a range from 1,100 cm⁻¹ to 1,200 cm⁻¹, inclusive. The second peak appears at a wave number in a range of more than 1,200 cm⁻¹ and less than or equal to 1,400 cm⁻¹. The third peak appears at a wave number in a range from 1,450 cm⁻¹ to 1,550 cm⁻¹, inclusive. And the fourth peak appears at a wave number in a range of more than 1,550 cm⁻¹ and less than or equal to 1,650 cm⁻¹. In a discharged state, a ratio I_{D3}/I_{D0} of a height I_{D3} of the third peak to a total I_{D0} of heights of the first peak, the second peak, the third peak, and the fourth peak ranges from 0.18 to 1.42, inclusive.

### TECHNICAL FIELD

The present invention relates to an electrochemical device including a positive electrode containing a polyaniline compound.

### BACKGROUND

In recent years, electrochemical devices having intermediate performance between lithium ion secondary batteries and electric double layer capacitors have been attracting attention, and for example, the use of a conductive polymer as a positive electrode active material has been studied (for example, PTL 1). Since the electrochemical device containing the conductive polymer as the positive electrode active material is charged and discharged by adsorption (doping) and desorption (dedoping) of anions, the electrochemical device has a small reaction resistance and has higher output than output of a general lithium ion secondary battery.

As the conductive polymer, polyaniline is expected. PTL 2 proposes that in a polyaniline-containing positive electrode for a power storage device, the proportion of an oxidized form of polyaniline in the entire polyaniline is in a range from 0.01% to 75%.

### CITATION LIST

### Patent Literature

PTL 1: Unexamined Japanese Patent Publication No. 2014-35836
PTL 2: Unexamined Japanese Patent Publication No. 2014-130706

### SUMMARY

When polyaniline is used for the conductive polymer, the initial capacitance and float characteristics of the electrochemical device may not be sufficiently obtained.

One aspect of the present invention relates to an electrochemical device including: a positive electrode; a negative electrode; and an electrolytic solution. The positive electrode includes: an active layer containing a conductive polymer; and a positive current collector supporting the active layer. The conductive polymer contains a polyaniline compound. The active layer has a peak derived from the polyaniline compound in an infrared absorption spectrum, the peak includes: a first peak having a wave number appearing in a range from 1,100 cm⁻¹ to 1,200 cm⁻¹, inclusive; a second peak having a wave number appearing in a range of more than 1,200 cm⁻¹ and less than or equal to 1,400 cm⁻¹; a third peak having a wave number appearing in a range from 1,450 cm⁻¹ to 1,550 cm⁻¹, inclusive; and a fourth peak having a wave number appearing in a range of more than 1,550 cm⁻¹ and less than or equal to 1,650 cm⁻¹. In a discharged state, a ratio I_{D3}/I_{D0} of a height I_{D3} of the third peak to a total I_{D0} of heights of the first peak, the second peak, the third peak, and the fourth peak ranges from 0.18 to 1.42, inclusive.

According to the present invention, it is possible to suppress deterioration of float characteristics of the electrochemical device while the initial capacitance of the electrochemical device is increased.

### BRIEF DESCRIPTION OF THE DRAWINGS

FIG. 1 is a longitudinal sectional view illustrating an electrochemical device according to an exemplary embodiment of the present invention.

FIG. 2 is a graph showing an IR spectrum of an active layer of a positive electrode of an electrochemical device in a discharged state of Example 1 of the present invention.

FIG. 3 is a graph showing an IR spectrum of an active layer of a positive electrode of an electrochemical device in a discharged state of Comparative Example 1.

### DESCRIPTION OF EMBODIMENT

An electrochemical device according to an exemplary embodiment of the present invention includes a positive electrode, a negative electrode, and an electrolytic solution. The positive electrode includes: an active layer containing a conductive polymer as a positive electrode active material; and a positive current collector supporting the active layer. The conductive polymer contains a polyaniline compound. In the electrochemical device described above, during charge, the conductive polymer is doped with anions in the electrolytic solution, and lithium ions in the electrolytic solution are absorbed in the negative electrode active material included in the negative electrode. During discharge, anions desorbed from the conductive polymer move into the electrolytic solution and lithium ions released from the negative electrode active material move into the electrolytic solution. In the present invention, the conductive polymer includes the polymer in a state of being hardly conductive or a state of being non-conductive when dedoped.

The active layer has peaks derived from a polyaniline compound in an infrared absorption spectrum (hereinafter, referred to as an IR spectrum). The peaks includes the first peak to the fourth peak. The first peak appears at a wave number in a range from 1,100 cm⁻¹ to 1,200 cm⁻¹, inclusive. The second peak appears at a wave number in a range of more than 1,200 cm⁻¹ and less than or equal to 1,400 cm⁻¹. The third peak appears at a wave number in a range from 1,450 cm⁻¹ to 1,550 cm⁻¹, inclusive. The fourth peak appears at a wave number in a range of more than 1,550 cm⁻¹ and less than or equal to 1,650 cm⁻¹.

The polyaniline compound contains a structural unit (hereinafter, also referred to as an IP^{.+} structure) represented by Formula (1) below, and the first peak is presumed to be a peak derived from a nitrogen atom of the IP^{.+} structure. At least some of hydrogen atoms bonded to the benzene ring in the structural units represented by Formula (1) below and Formulas (2) to (4) described later may be substituted with a substituent (a halogen atom such as a chlorine atom, an alkyl group such as a methyl group, a sulfonic acid group, a carboxyl group, and the like) other than a hydrogen atom.

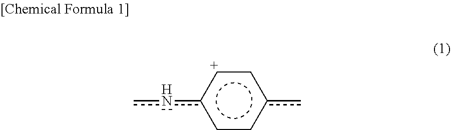

The polyaniline compound contains a structural unit (hereinafter, also referred to as an IP⁺ structure) represented by Formula (2) below, and the second peak is presumed to be a peak derived from a nitrogen atom of the IP⁺ structure.

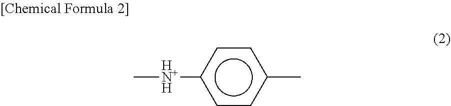

The polyaniline compound contains a structural unit having a benzenoid skeleton (also referred to as an IP structure) represented by Formula (3) below, and the third peak is a peak derived from a nitrogen atom of the IP structure.

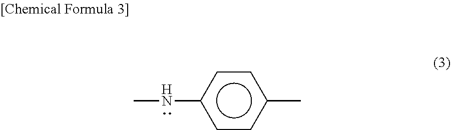

The polyaniline compound contains a structural unit having a quinoid skeleton (also referred to as an NP structure) represented by Formula (4) below, and the fourth peak is a peak derived from a nitrogen atom of the NP structure.

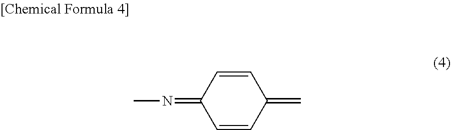

In a discharged state, a ratio I_{D3}/I_{D0} of the height I_{D3} of the third peak to a total I_{D0} of the heights of the first peak, the second peak, the third peak, and the fourth peak ranges from 0.18 to 1.42, inclusive. The peak value refers to the maximum absorbance (maximum value) of a peak in an IR spectrum with the vertical axis as the absorbance and the horizontal axis as the wave number. The height of the peak is obtained as follows. A line segment is drawn that passes through two points at minimum values of absorbance which are located on both sides of the peak point and located closest to the peak point in the IR spectrum. A value of absorbance at a point where a perpendicular line drawn from the peak point to the horizontal axis intersects the line segment is obtained as a base value. Then, the height of the peak is determined by subtracting the base value from at the peak value.

In the above description, the discharged state means a state in which the depth of discharge (percentage of the discharge amount in the capacitance at full charge) of the electrochemical device becomes more than or equal to 90%. And an end-of-discharge voltage means the voltage between terminals at the time when the discharging has been completed to reach this state. The end-of-discharge voltage can be set according to the design of the electrochemical device such that the depth of discharge is in a range from 90% to 100%. The end-of-discharge voltage is determined by a combination of the conductive polymer and the negative electrode active material. For example, when a π-conjugated polymer such as a polyaniline compound is used as the conductive polymer and a carbon material in which lithium ions are inserted and desorbed is used as the negative electrode active material, for example, the end-of-discharge voltage can be set in a range from 2.0 V to 2.7 V. Typically, the discharged state refers to a state in which the charged electrochemical device is discharged to a voltage of 2.7 V.

When the ratio I_{D3}/I_{D0} is within a range from 0.18 to 1.42, inclusive, deterioration of float characteristics is suppressed while a high initial capacitance is obtained. The float characteristic is an index of the degree of deterioration of the electrochemical device when float charge in which a constant voltage is continuously applied to the electrochemical device is performed. It can be said that a small decrease in capacitance at the time of float charge indicates better float characteristics.

When the ratio I_{D3}/I_{D0} is more than or equal to 0.18, the number of adsorption sites of anions in the polyaniline compound increases, the amount of anions adsorbed to the polyaniline compound during charge increases. As a result, a positive electrode with high capacity is obtained, and the initial capacitance is increased. Meanwhile, when the ratio I_{D3}/I_{D0} is more than 1.42, the reactivity of the polyaniline compound increases, the electrolytic solution comes into contact with the polyaniline compound during float charge. As a result, decomposition and deterioration of the electrolytic solution are likely to occur, and the float characteristics may be deteriorated. In any case of initial charge and after float charge, the ratio I_{D3}/I_{D0} ranges preferably from 0.4 to 1, inclusive from the viewpoint of easily obtaining a high discharge capacitance.

In addition, in a charged state, the ratio I_{C1}/I_{C0} of the height I_{C1} of the first peak to the total I_{C0} of the heights of the first peak, the second peak, the third peak, and the fourth peak is preferably from 0.3 to 2.5, inclusive. When the I_{C1}/I_{C0} ratio is more than or equal to 0.3, the amount of anions desorbed from the polyaniline compound during discharge increases, and the initial capacitance tends to be increased. On the other hand, when the I_{C1}/I_{C0} ratio is less than or equal to 2.5, deterioration of float characteristics is easily suppressed. In this case, the reactivity of the polyaniline compound is easily appropriately controlled, and decomposition and deterioration of the electrolytic solution due to contact with the polyaniline compound during float charge is easily suppressed. Further, it is easy to prepare the electrolytic solution. In any case of initial charge and after float charge, the ratio I_{C1}/I_{C0} ranges more preferably from 0.7 to 2, inclusive from the viewpoint of easily obtaining a high discharge capacitance.

Meanwhile, the charged state means a state in which the depth of discharge of the electrochemical device becomes less than or equal to 10%. And an end-of-charge voltage means the voltage between terminals at the time when charging has been completed to reach this state. The end-of-charge voltage can be set according to the design of the electrochemical device such that the depth of discharge is in a range from 0% to 10%. The end-of-charge voltage is determined by a combination of the conductive polymer and the negative electrode active material. For example, when a π-conjugated polymer such as a polyaniline compound is used as the conductive polymer and a carbon material in which lithium ions are inserted and desorbed is used as the negative electrode active material, for example, the end-of-charge voltage can be set in a range from 3.6 V to 3.9 V. Typically, the charged state refers to a state in which the electrochemical device is charged to a voltage of 3.6 V.

The ratio I_{D3}/I_{D0} and the ratio I_{C1}/I_{C0} can be adjusted by, for example, the temperature during aging treatment (application of a predetermined voltage) performed after assembly of the electrochemical device. The ratio I_{C1}/I_{C0} may be adjusted by the concentration of the lithium salt (anion) in the electrolytic solution.

The IR spectrum is obtained by the following method. The positive electrode is removed from the electrochemical device in the discharged or charged state. The positive electrode is washed with dimethyl carbonate (DMC) and vacuum-dried at 25° C. for 24 hours to obtain a sample of the positive electrode. The IR spectrum of the active layer on the surface of the sample is measured using a Fourier transform infrared spectrophotometer (FT-IR). As the FT-IR measuring apparatus, “IR Tracer-100” manufactured by Shimadzu Corporation can be used.

### (Active Layer)

The active layer contains at least a polyaniline compound as a conductive polymer. The polyaniline compound includes polyaniline and derivatives thereof. The derivatives of polyaniline mean polymers having polyaniline as a basic skeleton. For example, some of the hydrogen atoms of the benzene ring contained in the polyaniline skeleton may be substituted with an alkyl group such as a methyl group, a halogen atom such as a chlorine atom, a sulfonic acid group, a carboxyl group, or the like. The polyaniline compound is a π-conjugated polymer. The polyaniline compound may be used alone or in combination of two or more types thereof. The weight-average molecular weight of the polyaniline compound is not particularly limited and in a range, for example, from 1,000 to 100,000, inclusive.

The active layer may contain a conductive polymer other than the polyaniline compound. Examples of the conductive polymer other than the polyaniline compound include polypyrrole, polythiophene, polyfuran, polythiophene vinylene, polypyridine, and derivatives thereof. The derivatives of polypyrrole, polythiophene, polyfuran, polythiophene vinylene, and polypyridine mean polymers having, as a basic skeleton, polypyrrole, polythiophene, polyfuran, polythiophene vinylene, and polypyridine, respectively. The conductive polymer other than the polyaniline compound may be used alone or in combination of two or more types thereof.

The proportion of the polyaniline compound in the entire conductive polymer constituting the active layer may be more than or equal to 70 mass %, or more than or equal to 75 mass %, and the conductive polymer may be composed only of the polyaniline compound.

### (Method for Producing Active Layer)

The active layer is formed, for example, by immersing a positive current collector in a reaction solution containing a raw material of a conductive polymer and subjecting the raw material to electrolytic polymerization in the presence of the positive current collector. At this time, electrolytic polymerization is performed with the positive current collector as the anode, to form the active layer covering the surface of the positive current collector. The surface of the positive current collector immersed in the reaction solution may be covered with a carbon layer. In this case, the active layer is formed so as to cover the surface of the carbon layer.

The active layer may be formed by a method other than electrolytic polymerization. For example, a raw material may be synthesized by chemical polymerization or the like, the obtained conductive polymer may be mixed with a binder or the like to prepare a positive electrode mixture paste, and the positive electrode mixture paste may be applied to a current collector and dried to form an active layer as a mixture layer. Alternatively, the active layer may be formed using the conductive polymer or a dispersion of the conductive polymer.

The raw material used in electrolytic polymerization or chemical polymerization may be any polymerizable compound capable of producing a conductive polymer by polymerization. Examples of the raw material include monomers and oligomers. As the raw material monomer, for example, an aniline compound is used. As the aniline compound, for example, aniline or a derivative thereof is used. The derivative of aniline means monomers having aniline as a basic skeleton. Examples of the raw material oligomer include oligomers of aniline compounds. The raw material may be used alone or in combination of two or more types thereof.

It is desirable that electrolytic polymerization or chemical polymerization is carried out using a reaction solution containing an anion (dopant). It is desirable that the dispersion liquid or solution of the conductive polymer also contains a dopant. The polyaniline compound and the like exhibit excellent conductivity by being doped with a dopant. For example, in chemical polymerization, a positive current collector may be immersed in a reaction solution containing a dopant, an oxidizing agent, and a raw material monomer, and then withdrawn from the reaction solution and dried. In the electrolytic polymerization, a positive current collector and a counter electrode may be immersed in a reaction solution containing a dopant and a raw material monomer, and a current may be passed between the positive current collector as an anode and the counter electrode as a cathode.

As the solvent of the reaction solution, water may be used, or a non-aqueous solvent may be used in consideration of solubility of the monomer. As the non-aqueous solvent, alcohols and the like can be used. A dispersion medium or solvent of the conductive polymer is also exemplified by water and the non-aqueous solvent described above.

Examples of the dopant include a sulfate ion, a nitrate ion, a phosphate ion, a borate ion, a benzenesulfonate ion, a naphthalenesulfonate ion, a toluenesulfonate ion, a methanesulfonate ion (CF₃SO₃⁻), a perchlorate ion (ClO₄⁻), a tetrafluoroborate ion (BF₄⁻), a hexafluorophosphate ion (PF₆⁻), a fluorosulfate ion (FSO₃⁻), a bis(fluorosulfonyl)imide ion (N(FSO₂)₂⁻), a bis(trifluoromethanesulfonyl)imide ion (N(CF₃SO₂)₂⁻), an oxalate ion, and a formate ion. The dopant may be used alone or in combination of two or more types thereof.

The dopant may be a polymer ion. Examples of the polymer ion include ions of polyvinylsulfonic acid, polystyrenesulfonic acid, polyallylsulfonic acid, polyacrylsulfonic acid, polymethacrylsulfonic acid, poly(2-acrylamido-2-methylpropanesulfonic acid), polyisoprenesulfonic acid, and polyacrylic acid. These dopants may be a homopolymer or a copolymer of two or more monomers. The polymer ion may be used alone or in combination of two or more types thereof.

The active layer formed on the positive current collector may be subjected to reduction treatment. With this treatment, the dopant with which the conductive polymer constituting the active layer has been doped may be desorbed. In this case, in the conductive polymer, active sites contributing to charge and discharge can be increased. The reduction treatment may be performed by electrochemical reduction or chemical reduction. The reduction treatment can be performed, for example, by bringing a reducing agent into contact with the active layer, and may be performed while a voltage is applied, as necessary.

Examples of the reducing agent include ascorbic acids (ascorbic acid, isoascorbic acid, salts thereof, and the like), butylhydroxyanisole, hydrazine, aldehydes, formic acid, oxalic acid, and gallic acid. As the aldehydes, any of aliphatic aldehydes (acetaldehyde, propionaldehyde, butylaldehyde, and the like), alicyclic aldehydes, and aromatic aldehydes may be used in addition to formaldehyde, glyoxal, and the like. Among these reducing agents, it is preferable to use a carbonyl group-containing compound, for example, ascorbic acid or a salt thereof, formic acid, oxalic acid, gallic acid, or the like. Among them, it is preferable to use a carboxy group-containing compound (for example, formic acid, oxalic acid, and gallic acid) as a reducing agent.

The ratio I_{D3}/I_{D0} and the ratio I_{C1}/I_{C0} may be adjusted by changing conditions such as the type of the reducing agent, the amount of the reducing agent, the reduction temperature, the reduction time, and the voltage to be applied at the time of reduction in the reduction treatment.

The thickness of the active layer can be controlled, for example, by appropriately changing the current density and polymerization time of electrolysis or adjusting the amount of the conductive polymer to be attached onto the positive current collector. The thickness of the active layer is, for example, from 10 μm to 300 μm, inclusive, per one surface. In the active layer, all or a part of the dopant may be desorbed by the reduction treatment.

### (Positive Current Collector)

As the positive current collector, for example, a sheet-shaped metallic material is used. As the sheet-shaped metallic material, for example, a metal foil, a metal porous body, a punching metal, an expanded metal, an etching metal, or the like is used. As a material of the positive current collector, for example, aluminum, an aluminum alloy, nickel, titanium, and the like can be used, and aluminum and an aluminum alloy are preferably used. The thickness of the positive current collector is, for example, from 10 μm to 100 μm, inclusive.

### (Carbon Layer)

The surface of the positive current collector may be covered with a carbon layer. In this case, the carbon layer interposed between the positive current collector and the active layer reduces the resistance between the positive current collector and the active layer, which is advantageous for increasing the capacity of the positive electrode and improving the float characteristics. When there is a region not covered with the carbon layer on the surface of the positive current collector, the active layer may be disposed directly on the positive current collector in the region.

The carbon layer is formed, for example, by depositing a conductive carbon material on the surface of the positive current collector. The carbon layer may also be formed by applying a carbon paste to the surface of the positive current collector and drying the coating film. The carbon paste contains, for example, a conductive carbon material, a polymer material, and water or an organic solvent. The thickness of the carbon layer is, for example, from 1 μm to 20 μm, inclusive.

As the conductive carbon material, graphite, hard carbon, soft carbon, carbon black, or the like is used. Among these materials, carbon black is preferable because it is easy to form a thin carbon layer having excellent conductivity. The average particle diameter (D50) of the conductive carbon material is, for example, from 10 nm to 100 nm, inclusive. The average particle diameter (D50) is a median diameter in a volume-based particle size distribution obtained with a laser diffraction particle size distribution analyzer. As the polymer material, fluororesin, acrylic resin, polyvinyl chloride, polyolefin resin, styrene-butadiene rubber (SBR), water glass (polymer of sodium silicate), and the like are used.

### (Negative Electrode)

The negative electrode contains a negative electrode active material capable of electrochemically absorbing and releasing lithium ions. Examples of the negative electrode active material include a carbon material, a metal compound, an alloy, and a ceramic material. As the carbon material, graphite, non-graphitizable carbon (hard carbon), and easily graphitizable carbon (soft carbon) are preferable, and graphite and hard carbon are particularly preferable. Examples of the metal compound include silicon oxides and tin oxides. Examples of the alloy include silicon alloys and tin alloys. Examples of the ceramic material include lithium titanate and lithium manganate. The negative electrode active material may be used alone or in combination of two or more types thereof. Among these materials, a carbon material is preferable in terms of being capable of decreasing the potential of the negative electrode.

The negative electrode may include: a negative electrode material layer containing a negative electrode active material; and a negative current collector supporting the negative electrode material layer. As the negative current collector, for example, a sheet-shaped metallic material is used. As the sheet-shaped metallic material, for example, a metal foil, a metal porous body, a punching metal, an expanded metal, an etching metal, or the like is used. As a material of the negative current collector, it is possible to use, for example, copper, a copper alloy, nickel, and stainless steel. The thickness of the negative current collector is, for example, in a range from 10 μm to 100 μm, inclusive.

The negative electrode material layer may contain a conductive agent, a binder, and the like in addition to the negative electrode active material. Examples of the conductive agent include carbon black and carbon fiber. Examples of the binder include resin materials, rubber materials, and cellulose derivatives. Examples of the resin material include fluororesins such as polyvinylidene fluoride and polytetrafluoroethylene. Examples of the rubber material include styrene-butadiene rubber, and examples of the cellulose derivative include carboxymethyl cellulose and salts thereof.

The negative electrode material layer is formed by, for example, mixing the negative electrode active material, the conductive agent, and the binder with a dispersion medium to prepare a negative electrode mixture paste, and applying the negative electrode mixture paste to the negative current collector and then drying the negative electrode mixture paste.

The negative electrode is desirably pre-doped with lithium ions in advance. This decreases the potential of the negative electrode and therefore increases a difference in potential (that is, voltage) between the positive electrode and the negative electrode and improves energy density of the electrochemical device.

Pre-doping of the negative electrode with the lithium ions is advanced by, for example, forming a metallic lithium layer on the surface of the negative electrode material layer and impregnating the negative electrode including the metallic lithium layer with an electrolytic solution (for example, a nonaqueous electrolytic solution) having lithium-ion conductivity. At this time, lithium ions derived from the metallic lithium layer, which are eluted in the electrolytic solution, are absorbed in the negative electrode active material. A step of pre-doping the negative electrode with lithium ions may be performed before assembling the electrode group, or pre-doping may be advanced after the electrode group is housed together with the electrolytic solution in a case of the electrochemical device.

### (Electrolytic Solution)

The electrolytic solution has ion conductivity and contains a lithium salt and a solvent that dissolves the lithium salt. In this case, doping and dedoping of the positive electrode with the anions of the lithium salt can be reversibly repeated. On the other hand, lithium ions derived from the lithium salt are reversibly absorbed to and released from the negative electrode.

In the preparation of the electrolytic solution, the concentration of the lithium salt in the electrolytic solution ranges, for example, from 1.0 mol/L to 2.5 mol/L, inclusive. In the discharged state, the concentration of the anion derived from the lithium salt in the electrolytic solution may range from 1.0 mol/L to 2.5 mol/L, inclusive. In this case, the ratio I_{C1}/I_{C0} is easily adjusted within a range from 0.3 to 2.5, inclusive.

Examples of the lithium salt include LiClO₄, LiBF₄, LiPF₆ (lithium hexafluorophosphate), LiAlCl₄, LiSbF₆, LiSCN, LiCF₃SO₃, LiFSO₃, LiCF₃CO₂, LiAsF₆, LiB₁₀Cl₁₀, LiCl, LiBr, LiI, LiBCl₄, LiN(FSO₂)₂, and LiN(CF₃SO₂)₂. The lithium salt may be used alone or in combination of two or more types thereof. Among these lithium salts, desirably used are at least one selected from the group consisting of a lithium salt having a halogen atom-containing oxo acid anion suitable as the anions, and a lithium salt having an imide anion. An electrolytic solution containing lithium hexafluorophosphate is preferably used from the viewpoint of enhancing the ion conductivity of the electrolytic solution and suppressing corrosion of metal parts such as current collectors and leads. For example, a film of aluminum fluoride is formed on the surface of the current collector made of aluminum by the action of F derived from lithium hexafluorophosphate, and corrosion of the current collector is suppressed.

As the solvent, a non-aqueous solvent can be used. Examples of the non-aqueous solvent that can be used include cyclic carbonates such as ethylene carbonate, propylene carbonate, and butylene carbonate; chain carbonates such as dimethyl carbonate, diethyl carbonate, and ethyl methyl carbonate; aliphatic carboxylic acid esters such as methyl acetate, methyl propionate, and ethyl propionate; lactones such as γ-butyrolactone and γ-valerolactone; chain ethers such as 1,2-dimethoxyethane, 1,2-diethoxyethane, and ethoxymethoxyethane; and cyclic ethers such as tetrahydrofuran and 2-methyltetrahydrofuran. As the non-aqueous solvent, dimethylsulfoxide, 1,3-dioxolane, formamide, acetamide, dimethylformamide, dioxolane, acetonitrile, propionitrile, nitromethane, ethyl monoglyme, trimethoxymethane, sulfolane, methylsulfolane, 1,3-propanesultone, or the like may be used. The solvent may be used alone or in combination of two or more types thereof.

The electrolytic solution may contain an additive agent, as necessary. For example, an unsaturated carbonate such as vinylene carbonate, vinyl ethylene carbonate, or divinyl ethylene carbonate may be added as an additive agent for forming a coating film having high lithium-ion conductivity on a surface of the negative electrode.

### (Separator)

A separator is desirably interposed between the positive electrode and the negative electrode. Preferably used as the separator are, for example, a nonwoven fabric made of cellulose fiber, a nonwoven fabric made of glass fiber, and a microporous membrane, a fabric cloth, and a nonwoven fabric that are made of polyolefin. The thickness of the separator is, for example, in a range from 10 μm to 300 μm, inclusive, preferably from 10 μm to 40 μm, inclusive.

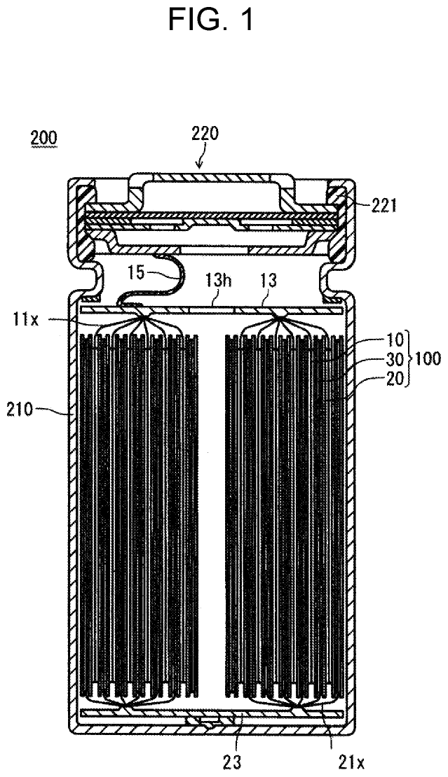

Hereinafter, a configuration of the electrochemical device according to an exemplary embodiment of the present invention will be described with reference to the drawing. FIG. 1 is a longitudinal sectional view of electrochemical device 200 according to the present exemplary embodiment.

Electrochemical device 200 includes: wound electrode group 100; an electrolytic solution (not shown); metallic bottomed case 210 housing electrode group 100 and the electrolytic solution; and sealing plate 220 sealing an opening of case 210. Gasket 221 made of resin is disposed on a peripheral portion of sealing plate 220, and the inside of case 210 is sealed by crimping an open end of case 210 to gasket 221.

Electrode group 100 has a structure in which belt-shaped positive electrode 10 and belt-shaped negative electrode 20 are wound together with separator 30 interposed therebetween. Positive electrode 10 includes: an active layer containing a conductive polymer; and a positive current collector supporting the active layer. The above-described active layer is used as the active layer of positive electrode 10. Negative electrode 20 includes: a negative electrode material layer containing a negative electrode active material; and a negative current collector supporting the negative electrode material layer.

Disk-shaped positive electrode current collecting member 13 has through hole 13h at the center thereof, and is welded to exposed part 11x of the positive current collector of positive electrode 10. Examples of the material of positive electrode current collecting member 13 include aluminum, an aluminum alloy, titanium, and stainless steel. The material of the positive electrode current collecting member may be the same as the material of the positive current collector. One end of tab lead 15 is connected to positive electrode current collecting member 13. The other end of tab lead 15 is connected to the inner surface of sealing plate 220. Thus, sealing plate 220 has a function as an external positive electrode terminal.

On the other hand, disk-shaped negative electrode current collecting member 23 is welded to exposed part 21x of the negative current collector. Examples of the material of the negative electrode current collecting member include copper, a copper alloy, nickel, and stainless steel. The material of the negative electrode current collecting member may be the same as the material of the negative current collector. Negative electrode current collecting member 23 is directly welded to a welding member provided on the inner bottom surface of case 210. Thus, case 210 has a function as an external negative electrode terminal.

In the above exemplary embodiment, the electrochemical device including the wound electrode group has been described, but the application range of the present invention is not limited to the above. The present invention can also be applied to an electrochemical device including a stacked electrode group formed by stacking a plate-shaped positive electrode and a plate-shaped negative electrode with a separator interposed therebetween.

### EXAMPLES

Hereinafter, the present invention will be described in more detail based on examples, but the present invention is not limited to the examples.

### Example 1

### (Production of Positive Electrode)

A stacked body was prepared that was obtained by forming a carbon black-containing carbon layer (thickness 2 μm) on both surfaces of a 30-μm-thick aluminum foil. An aqueous aniline solution containing aniline and sulfuric acid was prepared.

The stacked body and a counter electrode were immersed in the aqueous aniline solution, and electrolytic polymerization was performed at a current density of 20 mA/cm² for 20 minutes to attach a film of a conductive polymer (polyaniline) doped with sulfate ions (SO₄²⁻) onto the carbon layer on both surfaces of the stacked body.

The conductive polymer doped with the sulfate ions was reduced, thereby causing sulfate ions with which the conductive polymer has been doped to be desorbed. The reduction was performed by applying a voltage in a state where the stacked body on which the film of the conductive polymer was formed was immersed in an aqueous solution containing formic acid as a reducing agent at a concentration of 0.1 mol/L. In this way, the active layer containing the conductive polymer was formed. The active layer was thoroughly washed and then dried. In this way, a belt-shaped positive electrode was obtained. The thickness of the active layer was 35 μm per side.

### (Production of Negative Electrode)

A negative electrode mixture paste was obtained by kneading a mixed powder containing 97 parts by mass of hard carbon, 1 part by mass of carboxycellulose, and 2 parts by mass of styrene-butadiene rubber with water at a mass ratio of 40:60. The negative electrode mixture paste was applied to both surfaces of the negative current collector and dried to obtain a belt-shaped negative electrode including a negative electrode material layer having a thickness of 35 μm on both surfaces. As the negative current collector, a copper foil having a thickness of 20 μm was used. Next, a metallic lithium layer was formed on the negative electrode material layer in an amount calculated so that the negative electrode that had been pre-doped and was in an electrolytic solution had a potential of less than or equal to 0.2 V with respect to the potential of metallic lithium.

### (Production of Electrode Group)

The positive electrode obtained above and the negative electrode obtained above were wound with a separator interposed between the positive electrode and the negative electrode to obtain an electrode group. As the separator, a cellulose nonwoven fabric having a thickness of 35 μm was used.

### (Preparation of Electrolytic Solution)

A solvent was prepared by adding 0.2 mass % of vinylene carbonate to a mixture of propylene carbonate and dimethyl carbonate at a volume ratio of 1:1. LiPF₆ was dissolved as a lithium salt in the obtained solvent to prepare an electrolytic solution containing a hexafluoro phosphate ion (PF₆⁻) as an anion. The concentration of LiPF₆ in the electrolytic solution was 1.5 mol/L.

### (Production of Electrochemical Device)

The wound electrode group and the electrolytic solution were housed in a bottomed case having an opening to assemble the electrochemical device illustrated in FIG. 1. Thereafter, the electrochemical device was subjected to aging treatment to advance pre-doping of the negative electrode with lithium ions. The aging treatment was performed by applying a voltage of 3.8 V to the electrochemical device for 24 hours in an environment of 28° C. The obtained electrochemical device was evaluated as follows.

### [Evaluation]

(IR Spectrum Measurement (I_{D3}/I_{D0}))

The electrochemical device after the aging treatment was discharged at a constant current of 1 A until the voltage reached 2.7 V. The discharge was performed in an environment of 25° C. In this way, an electrochemical device in a discharged state (depth of discharge: 95%) was obtained. The positive electrode was taken out from the electrochemical device in a discharged state, and the IR spectrum of the active layer of the positive electrode was measured by the method described above to obtain the ratio I_{D3}/I_{D0}.

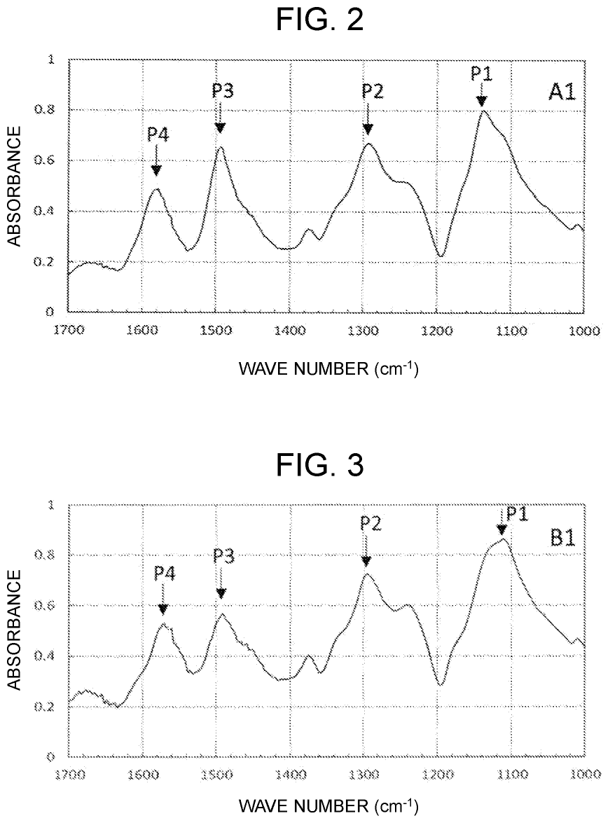

Here, an example of the IR spectrum of the active layer of the positive electrode in a discharged state of the electrochemical device will be described. FIG. 2 shows an IR spectrum of an active layer of a positive electrode of an electrochemical device A1 in a discharged state of Example 1. FIG. 3 shows an IR spectrum of an active layer of a positive electrode of an electrochemical device B1 in a discharged state of Comparative Example 1. P1 to P4 in FIGS. 2 and 3 represent the first peak to the fourth peak, respectively.

(IR Spectrum Measurement (I_{C1}/I_{C0}))

The electrochemical device after the aging treatment was charged at a constant current of 1 A until the voltage reached 3.6 V, and then a voltage of 3.6 V was applied to the electrochemical device for 60 minutes. The charge was performed in an environment of 25° C. In this way, an electrochemical device in a charged state (depth of discharge: 5%) was obtained. The positive electrode was taken out from the electrochemical device in a charged state, and the IR spectrum of the active layer of the positive electrode was measured by the method described above to obtain the ratio I_{C1}/I_{C0}.

### (Initial Capacitance)

The electrochemical device after the aging treatment was charged at a constant current of 1 A until the voltage reached 3.6 V, and then a voltage of 3.6 V was applied to the electrochemical device for 60 minutes. Thereafter, the electrochemical device was discharged at a constant current of 5 A until the voltage reached 2.5 V, and a discharge capacitance C1 at this time was obtained as an initial capacitance. Charge and discharge were performed in an environment of 25° C. The initial capacitance was expressed as a relative value when the initial capacitance of the electrochemical device B1 of Comparative Example 1 was 100.

### (Capacitance Retention Rate (Float Characteristics))

The electrochemical device after the initial capacitance was determined was charged in the same manner as described above in an environment of 60° C., and then further continuously charged (float charge) at a voltage of 3.45 V for 2,000 hours in an environment of 60° C. The electrochemical device after the float charge was discharged in an environment of 25° C. in the same manner as described above, and a discharge capacitance C2 at this time was obtained.

Using the discharge capacities C1 and C2 obtained above, the capacitance retention rate was determined from the following equation. A larger capacitance retention rate indicates a smaller decrease in capacitance during float charge and higher reliability of the electrochemical device.

Capacitance retention rate (%)=(discharge capacitance C2/discharge capacitance C1)×100

The capacitance retention rate was expressed as a relative value when the capacitance retention rate of the electrochemical device B1 of Comparative Example 1 is 100.

### Examples 2 to 6 and Comparative Examples 1 to 3

Electrochemical devices were produced and evaluated in the same manner as in Example 1 except that the temperature during the aging treatment was set to each of the values shown in Table 1.

The evaluation results of the electrochemical devices of Examples 1 to 6 and Comparative Examples 1 to 3 are shown in Table 1. The electrochemical devices of Examples 1 to 6 are A1 to A6, respectively, and the electrochemical devices of Comparative Examples 1 to 3 are B1 to B3, respectively.

TABLE 1

| | Temperature | Concentration of | | | | |
|---|---|---|---|---|---|---|
| | during aging | LiPF₆ in | | | Initial | Capacitance |
| Electrochemical | treatment | electrolytic solution | | | capacitance | retention rate |
| device | (° C.) | (mol/L) | I_{D3}/I_{D0} | I_{C1}/I_{C0} | (Index) | (Index) |
| B1 | 25 | 1.5 | 0.14 | 0.25 | 100 | 100 |
| A1 | 28 | 1.5 | 0.18 | 0.32 | 200 | 103 |
| A2 | 34 | 1.5 | 0.31 | 0.54 | 202 | 100 |
| A3 | 40 | 1.5 | 0.42 | 0.74 | 206 | 100 |
| A4 | 46 | 1.5 | 0.71 | 1.24 | 204 | 101 |
| A5 | 52 | 1.5 | 0.99 | 1.74 | 206 | 103 |
| A6 | 58 | 1.5 | 1.42 | 2.48 | 204 | 100 |
| B2 | 64 | 1.5 | 1.56 | 2.73 | 208 | 70 |
| B3 | 70 | 1.5 | 1.70 | 2.98 | 206 | 40 |

In the electrochemical devices A1 to A6, a high initial capacitance and a high capacitance retention rate were obtained. In the electrochemical device B1, a low initial capacitance was obtained. In the electrochemical devices B2 and B3, the initial capacitance was high, but the capacitance retention rate was significantly reduced.

### Examples 7 to 10

Electrochemical devices were produced and evaluated in the same manner as in Example 1 except that the concentration of LiPF₆ in the electrolytic solution was changed to each of the values shown in Table 2 in the preparation of the electrolytic solution. The evaluation results of the electrochemical devices of Examples 7 to 10 are shown in Table 2. The electrochemical devices of Examples 7 to 10 are A7 to A10, respectively. Table 2 also shows the evaluation results of the electrochemical device A1.

TABLE 2

| | Temperature | Concentration of | | | | |
|---|---|---|---|---|---|---|
| | during aging | LiPF₆ in | | | Initial | Capacitance |
| Electrochemical | treatment | electrolytic solution | | | capacitance | retention rate |
| device | (° C.) | (mol/L) | I_{D3}/I_{D0} | I_{C1}/I_{C0} | (Index) | (Index) |
| A10 | 28 | 1.0 | 0.18 | 0.25 | 150 | 101 |
| A7 | 28 | 1.3 | 0.18 | 0.30 | 195 | 102 |
| A1 | 28 | 1.5 | 0.18 | 0.32 | 200 | 103 |
| A8 | 28 | 2.0 | 0.18 | 1.10 | 220 | 103 |
| A9 | 28 | 2.5 | 0.18 | 1.95 | 230 | 103 |

In all of the electrochemical devices A7 to A10, similarly to the electrochemical device A1, a high initial capacitance and a high capacitance retention rate were obtained. In particular, in the electrochemical devices A1, A7 to A9, a higher initial capacitance and a higher capacitance retention rate were obtained.

### INDUSTRIAL APPLICABILITY

An electrochemical device according to the present invention has a high capacitance and excellent float characteristic and is therefore suitable as various electrochemical devices, particularly as a back-up power source.

### REFERENCE MARKS IN THE DRAWINGS

100 electrode group
10 positive electrode
11x exposed part of positive current collector
13 positive electrode current collecting member
13h through hole
15 tab lead
20 negative electrode
21x exposed part of negative current collector
23 negative electrode current collecting member
30 separator
200 electrochemical device
210 case
220 sealing plate
221 gasket

1. An electrochemical device comprising:
a positive electrode;
a negative electrode; and
an electrolytic solution,
wherein:
the positive electrode includes:
an active layer containing a conductive polymer; and
a positive current collector supporting the active layer,
the conductive polymer contains a polyaniline compound,
an infrared absorption spectrum of the active layer has a first peak, a second peak, a third peak, and a fourth peak that are derived from the polyaniline compound,
the first peak appears at a wave number in a range from 1,100 cm⁻¹ to 1,200 cm⁻¹, inclusive,
the second peak appears at a wave number in a range of more than 1,200 cm⁻¹ and less than or equal to 1,400 cm⁻¹,
the third peak appears at a wave number in a range from 1,450 cm⁻¹ to 1,550 cm⁻¹, inclusive, and
the fourth peak appears at a wave number in a range of more than 1,550 cm⁻¹ and less than or equal to 1,650 cm⁻¹, and
in a discharged state, a ratio I_{D3}/I_{D0} of a height I_{D3} of the third peak to a total I_{D0} of heights of the first peak, the second peak, the third peak, and the fourth peak ranges from 0.18 to 1.42, inclusive.

2. The electrochemical device according to claim 1, wherein the ratio I_{D3}/I_{D0} ranges from 0.4 to 1.0, inclusive.

3. The electrochemical device according to claim 1, wherein in a charged state, the ratio I_{C1}/I_{C0} of the height I_{C1} of the first peak to the total I_{C0} of the heights of the first peak, the second peak, the third peak, and the fourth peak ranges from 0.3 to 2.5, inclusive.

4. The electrochemical device according to claim 3, wherein the ratio I_{C1}/I_{C0} ranges from 0.7 to 2.0, inclusive.
